(19) United States
(12) Patent Application Publication
(10) Pub. No.: US 2023/0272974 A1
(43) Pub. Date: Aug. 31, 2023

(54) GEOMETRIC MULTIFORMAT GRAIN DRYER

(71) Applicant: Otalicio PACHECO DA CUNHA, Sao Lepoldo (BR)

(72) Inventor: Otalicio PACHECO DA CUNHA, Sao Lepoldo (BR)

(21) Appl. No.: 18/173,632

(22) Filed: Feb. 23, 2023

Related U.S. Application Data
(60) Provisional application No. 63/486,334, filed on Feb. 22, 2023.

(30) Foreign Application Priority Data
Feb. 25, 2022 (BR) 102022003725-6

(51) Int. Cl. F26B 17/12; F26B 21/00

(52) U.S. Cl. CPC F26B 17/122; F26B 21/004; F26B 2200/06

(57) ABSTRACT

The disclosure provided herein is directed to a grain dryer, that dries grains such as soy, corn, rice, etc., that may comprise of three or more grain drying towers capable of being arranged in diverse geometric formats, for example, triangular, square, pentagonal, hexagonal, etc. The grain drying towers may comprise airducts arranged transversally in relation to each other and with each airduct containing multiple openings that may be arranged in each of its six faces. Faces of the airducts have interspaced openings where some regions of the airduct may or may not have an opening.

### CROSS REFERENCE TO RELATED APPLICATION

This application claims the benefit of Brazilian Patent Application Serial No. BR 102022003725-6 filed Feb. 25, 2022, and U.S. Provisional Patent Application Ser. No. 63/486,334 filed Feb. 22, 2023, the contents of these applications are hereby incorporated by reference in their entirety.

### BACKGROUND OF THE INVENTION

This disclosure generally relates to grain dryers used to dry grain, such as soybeans, corn, rice, etc. More specifically, the disclosure relates to configurations of three or more drying towers that are configured in connected arrangements such as triangular, squared, pentagonal, hexagonal, nonagonal, decagonal, etc.

Grain dryers are known in the art. Drying is one of the steps of pre-processing agricultural products which intends to remove part of the water contained in them. It is defined as a simultaneous process of transferring heat and mass (moisture) within the product and the drying air. Moisture removal is usually undertaken in such a way that the product is in balance with the air of the environment where it will be stored and preserves the appearance, nutritional qualities, and in the case of grains, the viability of the seed. Grain dryers using heated air are often used for drying. By increasing the temperature of the humid air, the relative humidity decreases and, consequently, the air's ability to absorb moisture increases.

One advancement that has taken place is disclosed by Patent Document BR202014003815-9. With reference to FIG. 1, this disclosure is directed at a grain drying tower having parallel and sinuous grain flow that flows through reverse cross airflow and radial airflow in an oblique “Z” form to dry grains, seeds, fodder, and fruits. Such materials are first subjected to parallel grain flow and reverse cross airflow to standardize the various moisture levels of the materials and their impurities. The materials are then subjected to sinuous grain flow and radial airflow in oblique “Z” form. Although efficient in improving drying time and decreasing energy expenditure by having parallel airducts through the entirety of the drying tower creating a common countercurrent flow that results in drying materials, further improvements are possible.

Thus it is a primary aspect of this disclosure to provide a geometric multiformat grain dryer that improves upon the art.

Another aspect of this disclosure is to provide a geometric multiformat grain dryer that increases grain drying capacity.

Yet another aspect of this disclosure is to provide a geometric multiformat grain dryer that decreases energy expenditures.

Another aspect of this disclosure is to provide a geometric multiformat grain dryer that is functional at positive ambient temperatures (e.g., 104° F. (40° C.)) and negative ambient temperatures (e.g., −22° F. (−30° C.)).

Yet another aspect of this disclosure is to provide a geometric multiformat grain dryer that uses a centralized heat source.

These and other aspects, features, and advantages of the invention will become apparent from the specification and claims.

### SUMMARY OF THE INVENTION

The disclosure provides various aspects of a geometric multiformat grain dryer.

In some aspects, the techniques described herein relate to a geometric multiformat grain dryer including: a first grain drying tower, a second grain drying tower, and a third grain drying tower; the first grain drying tower, the second grain drying tower, and the third grain drying tower including: a plurality of airducts having at least six faces; the plurality of airducts arranged in transverse fashion in relation to one another; the plurality of airducts having a plurality of openings in each of the at least six faces, wherein the plurality of openings are spaced along each of the plurality of airducts such that superficial segments without the plurality of openings are positioned between areas with the plurality of openings.

In some aspects, the techniques described herein relate to a geometric multiformat grain dryer further including the plurality of openings arranged in ventilation rings about the plurality of airducts, wherein plurality of openings in the ventilation rings are configured to permit communication of an airflow of drying air to an airflow of used air that exits.

In some aspects, the techniques described herein relate to a geometric multiformat grain dryer further including the ventilation rings are arranged in sequence, wherein the ventilation rings define a linear volume of airflow through the plurality of airducts.

In some aspects, the techniques described herein relate to a geometric multiformat grain dryer wherein the plurality of airducts having a first superior row of inlet airducts and a first inferior row of inlet airducts with a first row of outlet airducts positioned therebetween, and an airflow of drying air traversing through the first superior row of inlet airducts and the first inferior row of inlet airducts descends from the first superior row of inlet airducts and ascends from the first inferior row of inlet airducts, wherein the airflow of drying airflow becomes an airflow of used air upon entry into the first row of outlet airducts.

In some aspects, the techniques described herein relate to a geometric multiformat grain dryer wherein the first superior row of inlet airducts, the first inferior row of inlet airducts, and the first row of outlet airducts form a first module; and a second superior row of inlet airducts, a second inferior row of inlet airducts, and a second row of outlet airducts form a second module; and wherein the first module and the second module provide an orthogonal air.

In some aspects, the techniques described herein relate to a geometric multiformat grain dryer further including a grain flow received through a superior opening in the first grain drying tower, the second grain drying tower, and the third grain drying tower, wherein the grain flow undergoes a first 180° rotation during its descent through the first module and a second 180° rotation during its descent through the second module.

In some aspects, the techniques described herein relate to a geometric multiformat grain dryer further including a heater centrally located between the first grain drying tower, the second grain drying tower, and the third grain drying tower.

In some aspects, the techniques described herein relate to a geometric multiformat grain dryer further including the external face of the first grain drying tower, the second grain drying tower, and the third grain drying tower having the plurality of airducts closed off by a plurality of lids, such that the an airflow passing through the first grain drying tower, the second grain drying tower, and the third grain drying tower only exits the external face of the geometric multiformat grain dryer by way of at least one fan positioned between the first grain drying tower and the second grain drying tower.

In some aspects, the techniques described herein relate to a geometric multiformat grain dryer wherein the first grain drying tower, the second grain drying tower, and the third grain drying tower are arranged in a triangle.

In some aspects, the techniques described herein relate to a geometric multiformat grain dryer wherein the first grain drying tower, the second grain drying tower, the third grain drying tower, and a fourth grain drying tower are arranged in a square.

In some aspects, the techniques described herein relate to a geometric multiformat grain dryer wherein the first grain drying tower, the second grain drying tower, the third grain drying tower, a fourth grain drying tower, and a fifth grain drying tower are arranged in a pentagon.

In some aspects, the techniques described herein relate to a geometric multiformat grain dryer further including an insulation formed by a first layer of air between a first internal wall and a second internal wall, and a second layer of air between the second internal wall and ends of the plurality of the airducts closest to the second layer of air.

In some aspects, the techniques described herein relate to a geometric multiformat grain dryer including: a plurality of grain drying towers connected to one another by a plurality of exhaust housings having a suction diffuser on an exterior face; the plurality of grain drying towers having a plurality of modules; at least two of the plurality of modules each having a superior row of inlet airducts, an inferior row of inlet airducts, and a row of outlet airducts that is positioned between the superior row of inlet airducts and the inferior row of inlet airducts, wherein the superior row of inlet airducts and the inferior row of inlet airducts extend perpendicularly in relation to the row of outlet airducts; the superior row of inlet airducts and the inferior row of inlet airducts each having: at least one inlet airduct that extends from a first opened end to a second closed end; a plurality of ventilation rings positioned between the first opened end and the second closed end; and at least two superficial segments interspaced about the plurality of airducts; the row of outlet airducts having at least one outlet airduct that extends from a first opened end to a second opened end; a heater positioned centrally between the plurality of grain drying towers; the first opened end of the at least one inlet airduct in communication with the dryers; wherein the first opened end and the second opened end of the at least one outlet airduct is in communication with suction diffusers of the plurality of exhaust housings.

This has outlined, rather broadly, the features, advantages, solutions, and benefits of the disclosure in order that the description that follows may be better understood. Additional features, advantages, solutions, and benefits of the disclosure will be described in the following. It should be appreciated by those skilled in the art that this disclosure may be readily utilized as a basis for modifying or designing other structures and related operations for carrying out the same purposes of the present disclosure. It should also be realized by those skilled in the art that such equivalent constructions and related operation do not depart from the teachings of the disclosure as set forth in the appended claims. The novel features, together with further objects and advantages, will be better understood from the following description when considered in connection with the accompanying Figures. It is to be expressly understood, however, that each of the Figures is provided for the purpose of illustration and description only and is not intended as a definition of the limits of the present disclosure.

### BRIEF DESCRIPTION OF THE DRAWINGS

FIG. 1 is a perspective view of the prior art as it relates to BR202014003815-9, wherein it is shown that the airducts are all parallel within the entirety of the grain drying tower;

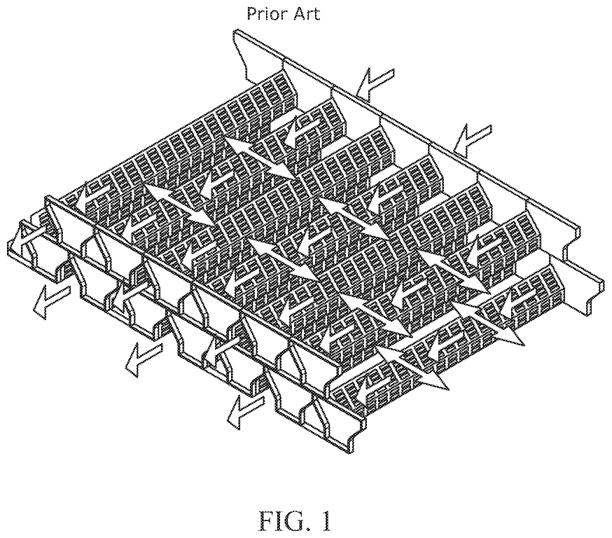

FIG. 2 is a perspective view of a geometric multiformat grain dryer according to an aspect of the disclosure, wherein an internal perspective view of a grain drying tower and the airflow of drying air and an airflow of used air of a plurality of transverse modules is shown;

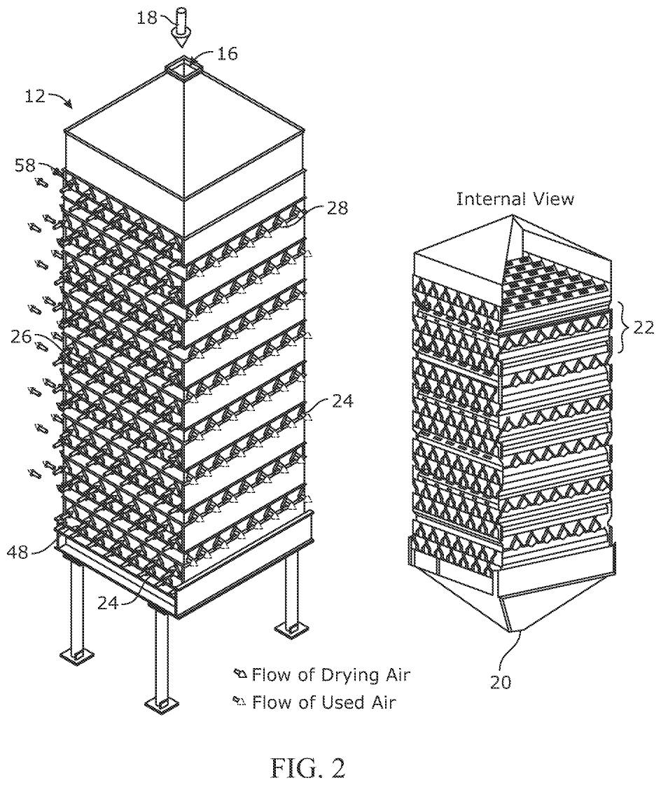

FIG. 3 is a perspective view of a geometric multiformat grain dryer according to an aspect of the disclosure, wherein an outlet airduct for the exit of an airflow of used air having six of a plurality of ventilation rings providing (A) and seven of a plurality of ventilation rings (B);

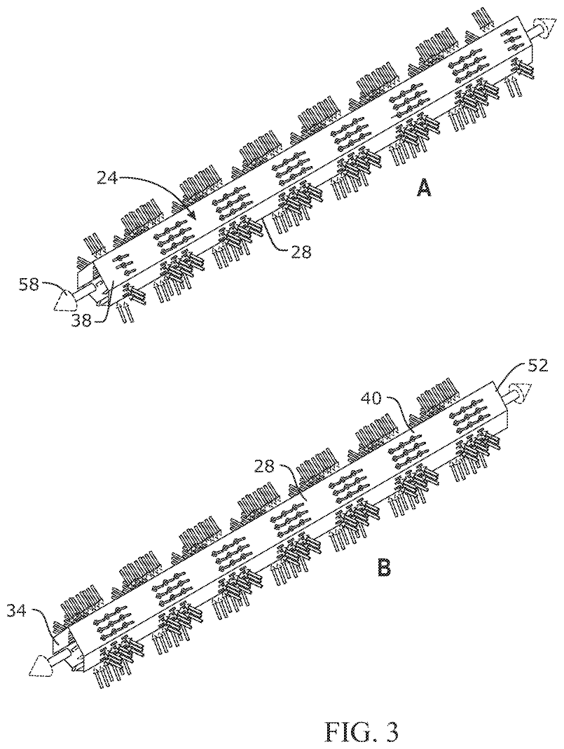

FIG. 4 is a perspective view of a geometric multiformat grain dryer according to an aspect of the disclosure, wherein an inlet airduct for the transport of an airflow of drying air is shown with a plurality of ventilation rings, including an inlet airduct having six of a plurality of ventilation rings (C); seven of a plurality of ventilation rings (D); and a detail view of a segment of an inlet airduct having a ventilation ring;

FIG. 5 is perspective views of a geometric multiformat grain dryer according to an aspect of the disclosure;

FIG. 6 is a frontal schematic view of a geometric multiformat grain dryer according to an aspect of the disclosure, wherein detail of a module 1 and module 2 are shown that comprise airducts with ventilation rings of orthogonal air (E1_{S1}, S1, E1ᵢ₁) and (E2_{S2}, S2, E2ᵢ₂), from the point of view of a heater;

FIG. 7 is a frontal schematic view of a geometric multiformat grain dryer according to an aspect of the disclosure, wherein detail of a module 1 and module 2 are shown that comprise airducts with ventilation rings of orthogonal air (E1_{S1}, S1, E1ᵢ₁) and (E2_{S2}, S2, E2ᵢ₂), the direction of airflow through the ventilation rings are indicated by arrows from the point of view of a heater;

FIG. 8 is a detail schematic view of a geometric multiformat grain dryer according to an aspect of the disclosure, wherein the direction of airflow through the ventilation rings are indicated by arrows from the point of view of a heater;

FIG. 9 is a lateral schematic view of a geometric multiformat grain dryer according to an aspect of the disclosure, wherein the point of view is from a suction diffuser;

FIG. 10 is a lateral schematic view of a geometric multiformat grain dryer according to an aspect of the disclosure, wherein the direction of airflow through the ventilation rings are indicated by the arrows, from the point of view of a suction diffuser;

FIG. 11 is a detail view of a geometric multiformat grain dryer according to an aspect of the disclosure, wherein the direction of airflow through the ventilation rings are indicated by the arrows, from the point of view of a suction diffuser;

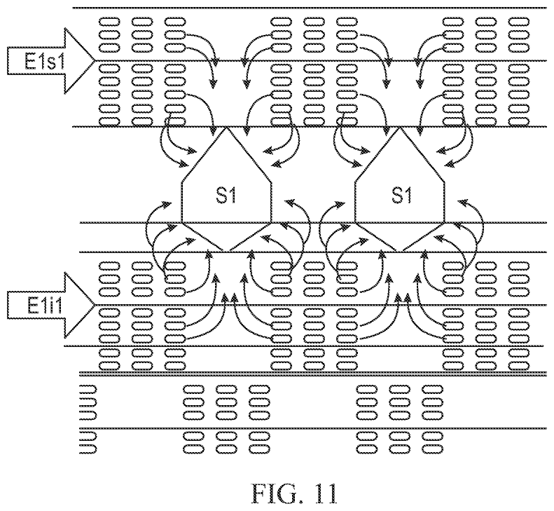

FIG. 11A is a detail view of a geometric multiformat grain dryer according to an aspect of the disclosure;

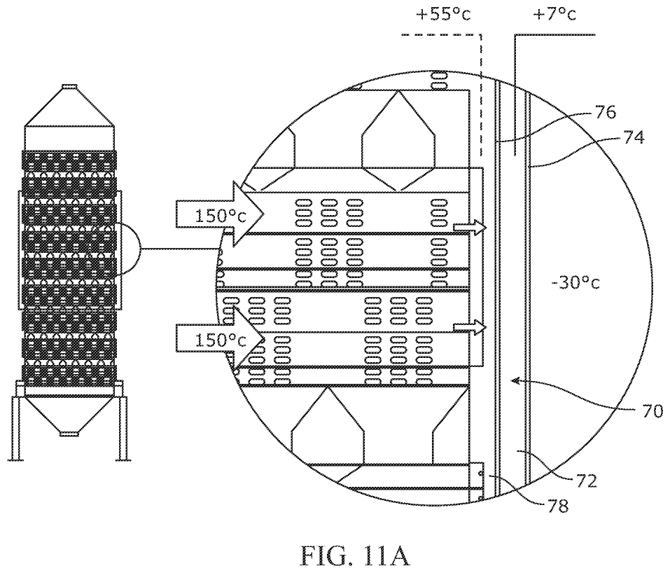

FIG. 12 is a superior view of a geometric multiformat grain dryer according to an aspect of the disclosure, wherein the direction of airflow through the ventilation rings are indicated by the arrows;

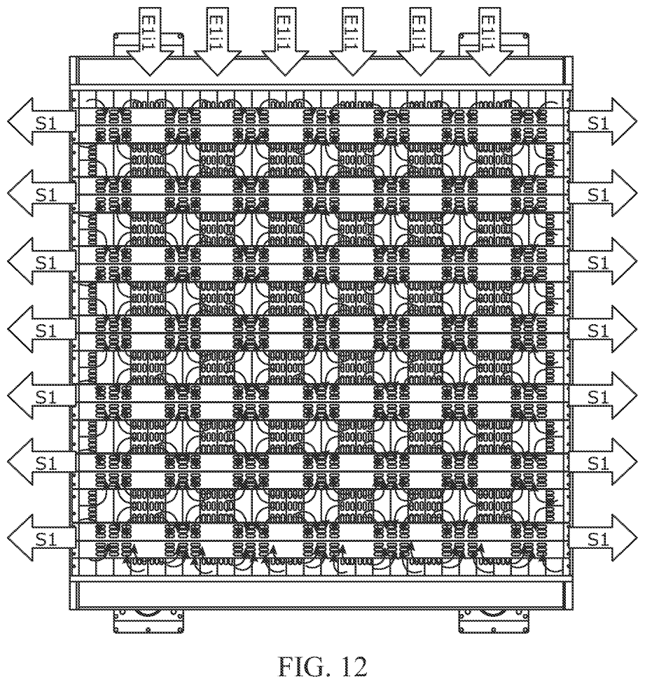

FIG. 13 is a schematic view of a geometric multiformat grain dryer according to an aspect of the disclosure, wherein a plurality airducts with their orthogonal air (Ec, Es, S1) and (Ei, Ec, Es) having ventilation rings are shown from the point of view a heater;

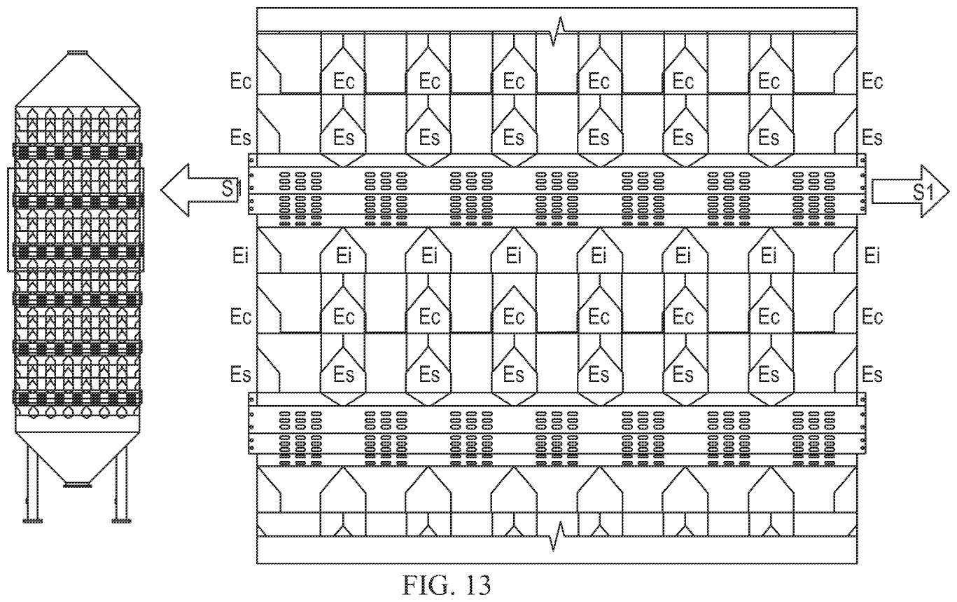

FIG. 14 is a schematic view of a geometric multiformat grain dryer according to an aspect of the disclosure, wherein a plurality airducts with their orthogonal air (Ec, Es, S1) and (Ei, Ec, Es) having ventilation rings are shown from the point of view a heater;

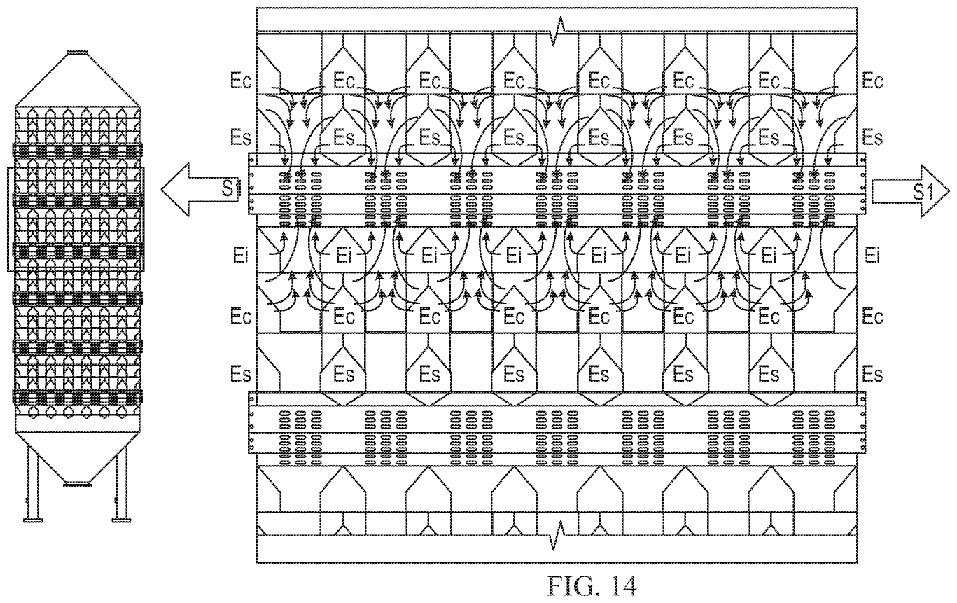

FIG. 15 is a schematic view of a geometric multiformat grain dryer according to an aspect of the disclosure, wherein a plurality airducts with their orthogonal air (Ec, Es, S1) and (Ei, Ec, Es) having ventilation rings are shown from the point of view a suction diffusor;

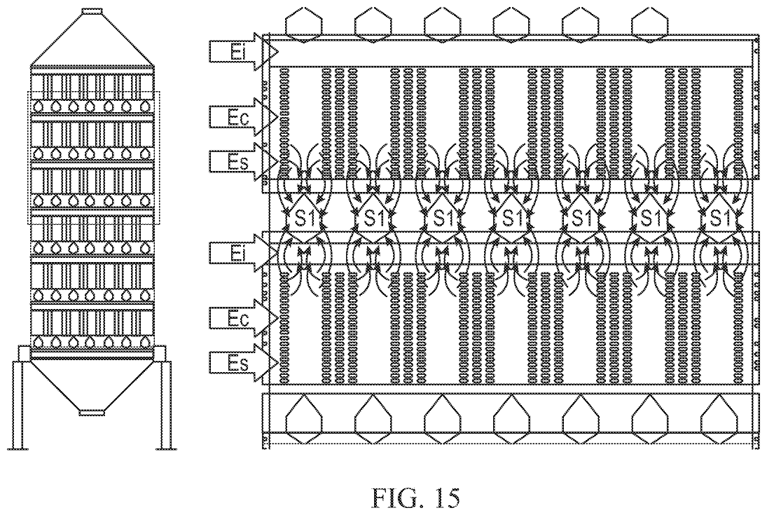

FIG. 16 is a schematic view of a geometric multiformat grain dryer according to an aspect of the disclosure;

FIG. 17 is a schematic view of a geometric multiformat grain dryer according to an aspect of the disclosure; and

FIG. 18 is a schematic view of a geometric multiformat grain dryer according to an aspect of the disclosure.

### DETAILED DESCRIPTION

The disclosure described herein is directed to different aspects of a geometric multiformat grain dryer 10. The detailed description set forth below, in connection with the appended drawings, is intended as a description of various configurations and is not intended to represent the only configurations in which the concepts described herein may be practiced. These descriptions include specific details for the purpose of providing a thorough understanding of the various concepts. It will be apparent, however, to those skilled in the art that these concepts may be practiced without these specific details. In some instances, well-known structures and components are shown in block diagram form in order to avoid obscuring such concepts. As described herein, the use of the term “and/or” is intended to represent an “inclusive OR”, and the use of the term “or” is intended to represent an “exclusive OR”.

The disclosure is described herein with reference to certain aspects, iterations, embodiments, and examples but it is understood that the disclosure can be embodied in many different forms and should not be construed as limited to the aspects set forth herein. In particular, the disclosure is described herein in regards to a grain, but it is understood that the disclosure can be sued in relation to seeds, fodder, etc.

Although the terms first, second, etc. may be used herein to describe various elements or components, these elements or components should not be limited by these terms. These terms are only used to distinguish one element or component from another. Hence, a first element discussed herein could be termed a second element without departing from the teachings of the present application. It is understood that actual systems or fixtures embodying the disclosure can be arranged in many different ways with many more features and elements beyond what is shown in the drawings. For the same or similar elements or features, the same reference numbers may be used throughout the disclosure.

It is to be understood that when an element or component is referred to as being “on” another element or component, it can be directly on the other element or intervening elements may also be present. Furthermore, relative terms such as “between”, “within”, “below”, and similar terms, may be used herein to describe a relationship of one element or component to another. It is understood that these terms are intended to encompass different orientations of the disclosure in addition to the orientation depicted in the figures.

With reference to the Figures aspects of a geometric multiformat grain dryer 10 are shown according to the disclosure. The geometric multiformat grain dryer 10 comprises one or more of a plurality of grain drying towers 12 (e.g., a first grain drying tower 12a, a second grain drying tower 12b, a third grain drying tower 12c, etc.) connected to one another by a plurality of exhaust housing 14 (e.g., a first exhaust housing 14a, a second exhaust housing 14b, and a third exhaust housing 14c) in a geometric configuration, including, triangular, square, pentagonal, hexagonal, etc. Such geometric configurations require the plurality of grain drying towers 12 comprise at least a first grain tower 12a to a third grain tower 12c. In further aspects, the plurality of grain drying towers 12 having a squared prism format.

In further aspects, with reference to the first grain tower 12a, each of the plurality of grain drying towers 12, are comprised of one or more of a superior opening 16 configured to receive a grain flow 18. The grain flow 18, in some aspects, is a volume of moist grains that continuously enter the superior opening 16 and descend by gravity and are dried to meet a drying specification set by an operator or the like and are discharged through a discharge opening 20.

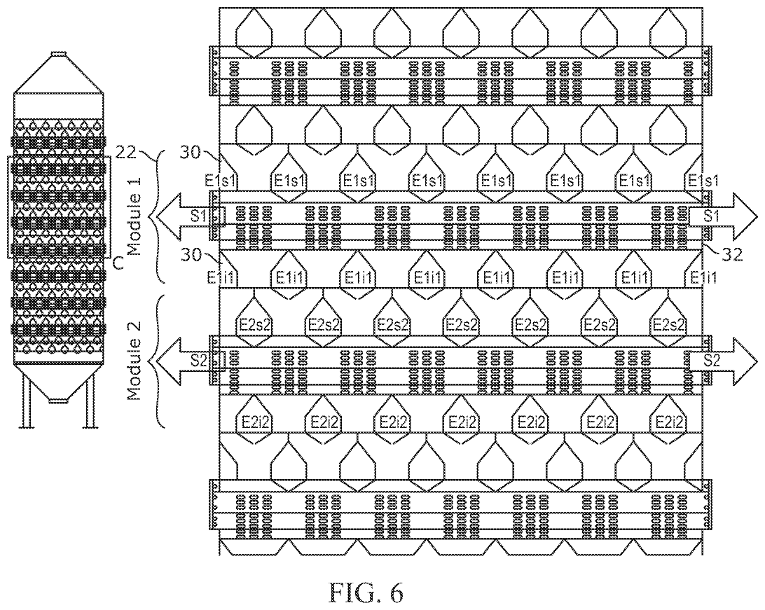

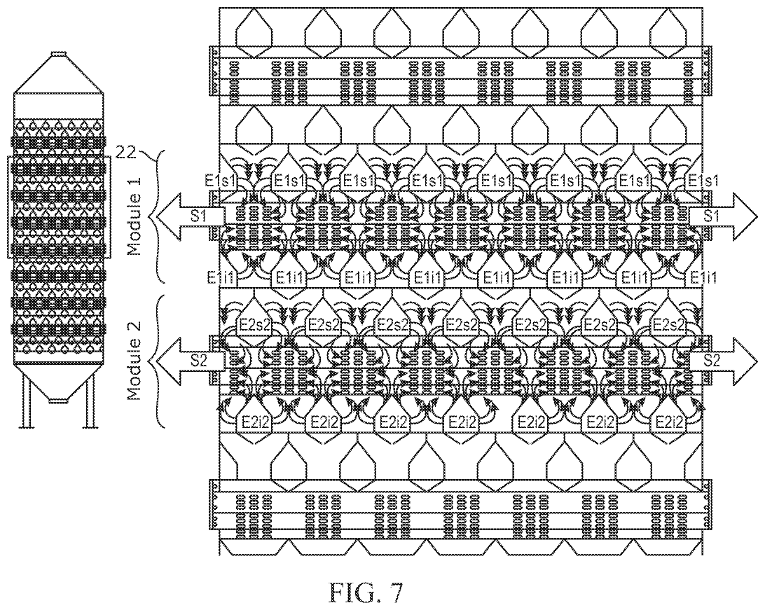

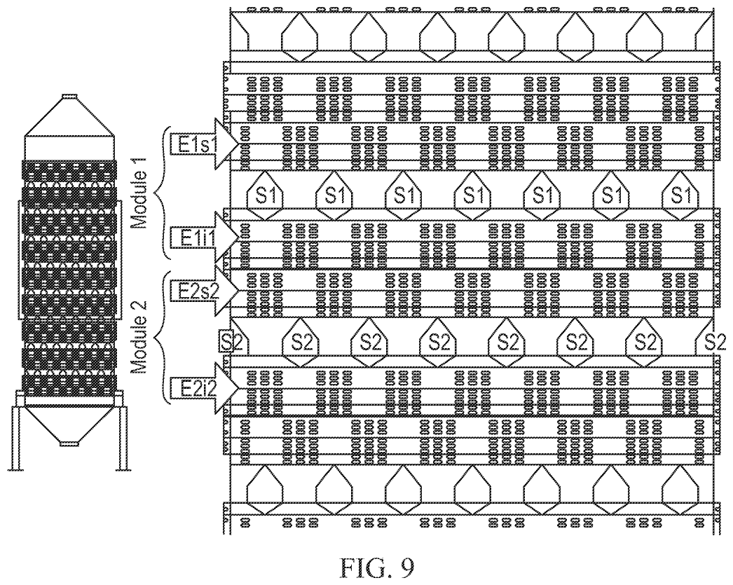

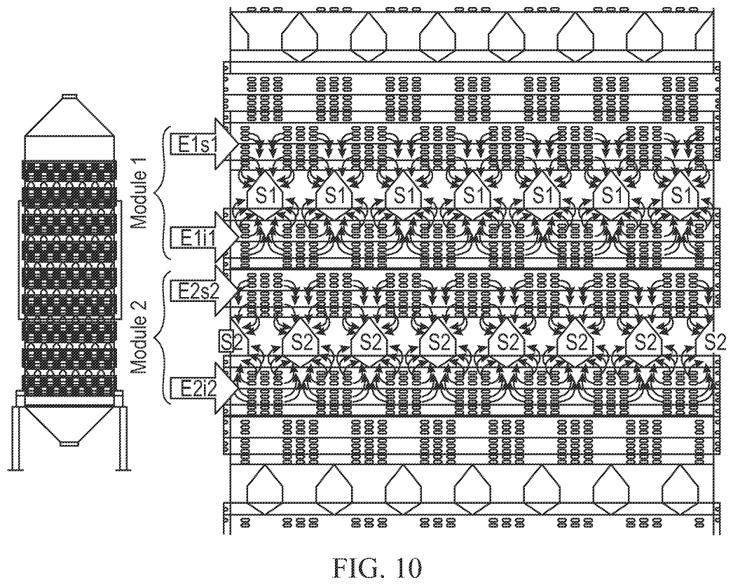

In other aspects, positioned between the superior opening 16 and the discharge opening 20 is a transverse module 22 (e.g., module 1 and module 2 depicted in FIGS. 6-10). In further aspects, the transverse module 22 is comprised of a plurality of airducts 24, including a plurality of inlet airducts 26 and a plurality of outlet airducts 28 described further herein, arranged in a perpendicular arrangement such that a row of inlet ducts 30 positioned in parallel horizontal arrangement that are arranged at 90° over a row of outlet ducts 32 positioned in parallel horizontal arrangement. In other such aspects, multiple of the transverse module 22 are positioned one on top of the other.

In still further aspects and with regard to at least FIG. 6, a first transverse module 22 comprises a first superior row of inlet airducts E1ₛ₁ and a first inferior row of inlet airducts E1ᵢ₁ positioned above and below a first row of outlet airducts (between S1), respectively, in a 90° arrangement thereby providing for orthogonal airflow as described further herein. A second transverse module 22 is positioned between the first transverse module 22 and comprises a second superior row of inlet airducts E2_{S2} and a second inferior row of inlet airducts E2ᵢ₂ that are positioned above and below a second row of outlet airducts S2.

In still other aspects, the plurality of airducts 24 have a hexagonal prismatic format and a plurality of ventilation rings 34, which in certain aspects comprise at least six or seven of the plurality of ventilation rings 34. In other aspects, each of the plurality of ventilation rings 34 are formed by a segment of the airduct 24 containing openings 36, such as stamped openings 36, on each of a plurality of faces 38 of the airduct 24 that are configured to allow the flow of drying air and/or used air. In further aspects, the plurality of ventilation rings 34 are spaced apart from one another about the airduct 24 such that a superficial segment 40 without the openings 36 are interspaced between the plurality of ventilation rings 34.

In still other aspects, each of the plurality of inlet airducts 26 extend from a first open end 42 to a second closed end 44 with the plurality of ventilation rings 34 and the plurality of superficial segments 40 positioned therebetween. In further aspects, the first open end 42 is positioned to an interior of the geometric multiformat grain dryer 10 such that the first open end 42 is in communication or direct communication with a heater 46, which in some aspects is centrally located in the geometric multiformat grain dryer 10. In this way, an airflow of drying air 48 is received by the plurality of inlet airducts 26 to pass through the plurality of grain drying towers 12 to promote drying of the grain flow 18. In other aspects, the second closed end 44 is covered by a lid 50 that closes off the second closed end 44.

In further aspects, each of the plurality of outlet airducts 28 extend from a first open end 52 to a second open end 54 with the plurality of ventilation rings 34 and the plurality of superficial segments 40 positioned therebetween. In other aspects, the first open end 52 and the second open end 54 are in communication with the plurality of exhaust housings 14, for example, the first open end 52 is in communication with the first exhaust housing 14a and the second open end 54 is in communication with the second exhaust housing 14a. In still other aspects, positioned within each of the plurality of exhaust housings 14 is a suction diffuser, such as a fan 56, that is positioned to an exterior of the geometric multiformat grain dryer 10 such that an airflow of used air 58 is pulled from each of the plurality of grain drying towers 12 and discharged away from the geometric multiformat grain dryer 10 through the plurality of exhaust housings 14. Hence the discharge of the airflow of used air 58 from the geometric multiformat grain dryer 10 occurs on the opposite side of the geometric multiformat grain dryer 10 from which the airflow of drying air 48 is pulled into the geometric multiformat grain dryer 10.

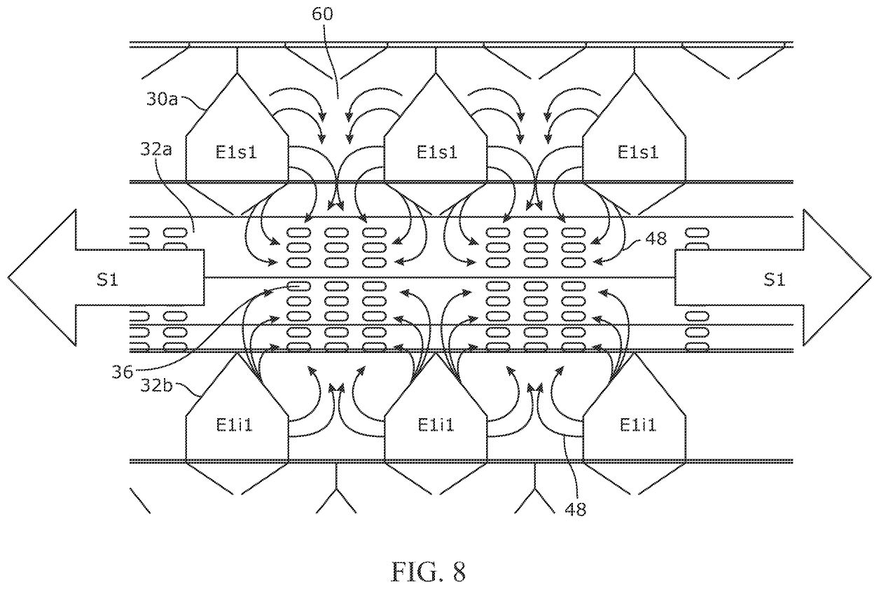

In yet further aspects, as the grain flow 18 descends through each of the plurality of grain drying towers 12, the grain flow 18 passes into a space 60 that exists between the plurality of airducts 24 that are arranged in the plurality of transverse modules 22. As the plurality of airducts 24 are transverse to each other, a grain making up the grain flow 18 is distributed homogenously in between the plurality of transverse modules 22 and exposed to orthogonal air as described herein. In further aspects and with reference to FIG. 8, as the grain flow 18 passes through the faces 38 of the first superior row of inlet airducts 30a (E1ₛ₁) the grain flow 18 comes into contact with the descending airflow of drying air 48 that is coming out of the first superior row of inlet airducts 30a. As the grain flow 18 continues to descend, the grain flow 18 comes in contact with the ascending airflow of drying air 48 that comes out of first inferior row of inlet airducts 30b (E1i₁). Both airflows of drying air 48 enter through the openings 36 in a first row of outlet airducts 32a positioned between the first superior row of inlet airducts 30a and the first inferior row of inlet airducts 30b, which at this point form the airflow of used air 58 (S1) that exits the geometric multiformat grain dryer 10.

In still further aspects, as the grain flow 18 descends through each of the plurality of grain drying towers 12, the grain flow 18 will encounter the descending airflow of drying air 48 coming from the first superior row of inlet airducts 30a (E1ₛ₁) and the grain within the grain flow 18 undergoes a rotation of 180°. Thereafter, when the grain flow 18 comes into contact with the airflow of used air 58 and at the moment of its displacement by gravity to the next inferior transverse module 22, the grain of the grain flow 18 undergoes another rotation of 180°, and as such, there is a constant turbulent movement in the grain flow 18. The turbulent flow during process will occur in each of the transverse modules 22 the grain flow 18 passes through and encounters orthogonal air (created by E1ₛ₁, S1, E1ᵢ₁ and E2_{S2}, S2, E2ᵢ₂) during a descent as described herein.

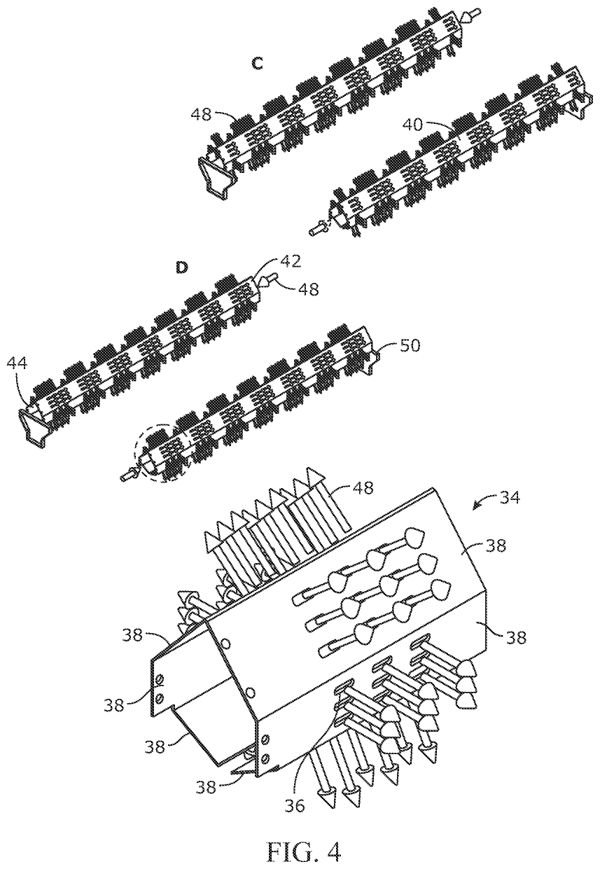

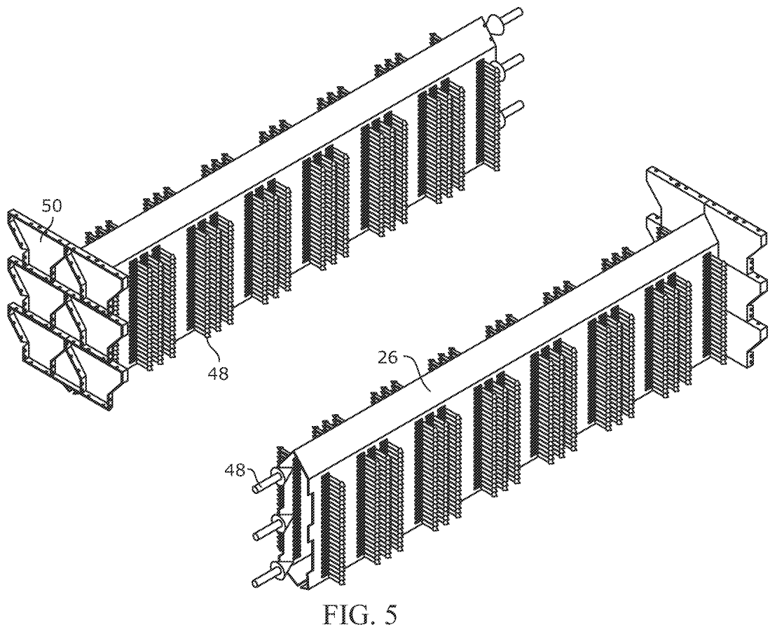

In yet further aspects, the airflow of drying air 48 enters the plurality of inlet airducts 26 through their respective first open ends 42 and exits through the plurality of ventilation rings 34 in an orthogonal fashion as indicated by the solid arrowheads shown in at least FIGS. 4 and 5. As noted, the airflow of drying air 48 originates from the heater 46 and is forced to enter the plurality of grain drying towers 12 by the fans 56 pulling the airflow of dying air 48 into the plurality of inlet airducts 26.

With further reference to FIG. 8, the airflow of drying air 48 goes through the first superior row of inlet airducts 30a (E1ₛ₁) and the first inferior row of inlet airducts 30b (E1ᵢ₁) and thereafter exits orthogonally, forming the airflow of drying air 48 indicated in the depiction. These airflows of drying air 48 enter the openings 36 in the first row of outlet airducts 32a and form the airflow of used air 58 (S1).

As the second closed end 44 of each of the plurality of inlet airducts 26 have an extremity closed by the lid 50, the airflow of drying air 48 is aspirated through the plurality of ventilation rings of the plurality of inlet airducts 26. So, this airflow of drying air 48 exits orthogonally from the plurality of inlet airducts 26 as described herein, which describe a sinuous movement and enters orthogonally into the plurality of outlet airducts 28 forming the airflow of used air 58.

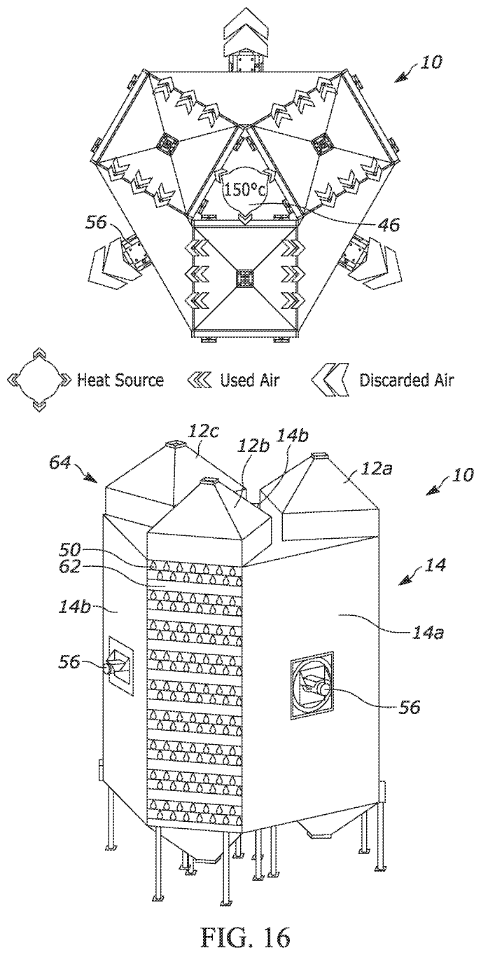

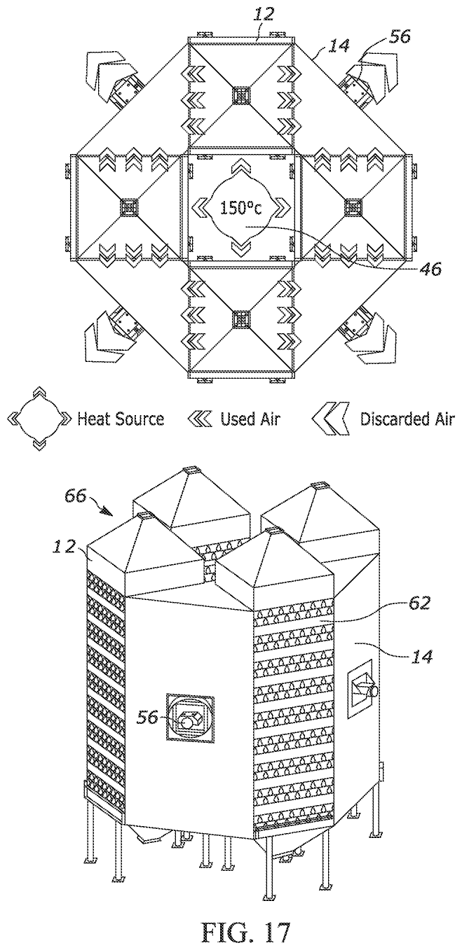

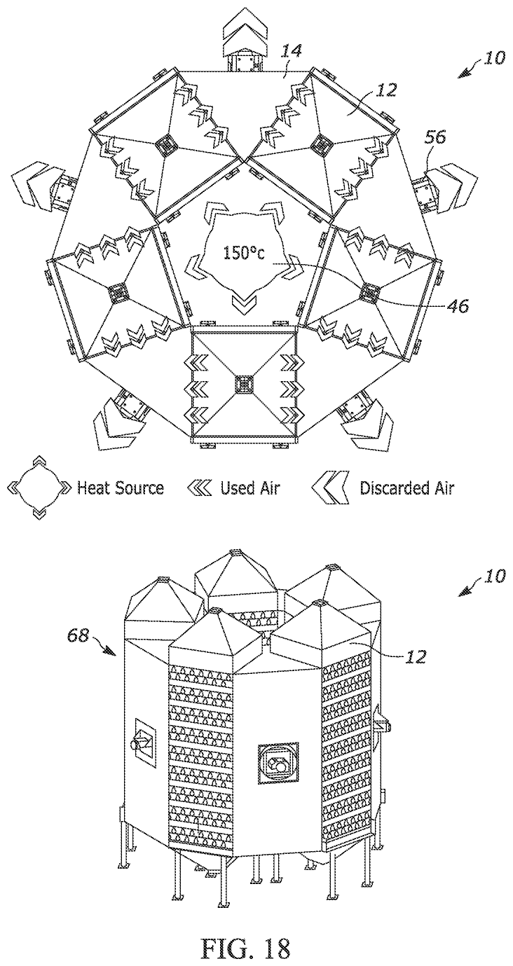

In other aspects and seen in FIG. 16, the geometric multiformat grain dryer 10 is comprised of three of the plurality of grain drying towers 12 that are connected to one another by three of the plurality of exhaust housings 14 therebetween in a triangular assembly 64. An external face 62 of each of the plurality of grain drying towers are closed by the lids 50 such that airflow pulled by the fans 56 can only exit the fans 12 thereby forming the airflow necessary to dry grains. FIG. 17 and FIG. 18 depict other aspects of the present invention that comprise more than three of the plurality of grain drying towers 12; by example a square assembly 66 and a pentagonal assembly 68.

In still further aspects, the plurality of grain drying towers 12 comprise insulation 70. In some such aspects, the insulation 70 is configured to insulate against low external temperatures, such as by way of double insulation. As such, operation of the geometric multiformat grain dryer 10 is possible up to temperatures up to 302° F. (150° C.). For example, an air layer 72 positioned within a first inner wall 74 and a second inner wall 76 of the plurality of the plurality of grain dryers 12 is approximately 44.6° F. (7° C.) and the temperature between a second air layer 78 between the second inner wall 76 and the plurality of airducts 24 is approximately 131° F. (55° C.). In this way, it is possible to operate the geometric multiformat grain dryer 10 efficiently, even at harshly negative external temperatures.

Therefore, a geometric multiformat grain dryer 10 has been provided that increases grain drying capacity; decreases energy expenditures; is functional at positive ambient temperatures (e.g., 104° F. (40° C.)) and negative ambient temperatures (e.g., −22° F. (−30° C.)); uses a centralized heat source, and improves upon the art.

From the above discussion and accompanying figures and claims it will be appreciated that the geometric multiformat grain dryer 10 offers many advantages over the prior art. Although the present disclosure and its advantages have been described in detail, it should be understood that various changes, substitutions, modifications, and alterations can be made herein without departing from the technology of the disclosure as defined by the appended claims. The scope of the present application is not intended to be limited to the particular configurations of the process, machine, manufacture, composition of matter, means, methods and steps described in the specification only expressly stated otherwise. As one of ordinary skill in the art will readily appreciate from the disclosure, processes, machines, manufacture, compositions of matter, means, methods, or steps, presently existing or later to be developed that perform substantially the same function or achieve substantially the same result as the corresponding configurations described herein may be utilized according to the present disclosure. Accordingly, the appended claims are intended to include within their scope such processes, machines, manufacture, compositions of matter, means, methods, or steps.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein

What is claimed is:

1. A geometric multiformat grain dryer comprising:
a first grain drying tower, a second grain drying tower, and a third grain drying tower;
the first grain drying tower, the second grain drying tower, and the third grain drying tower comprising:
a plurality of airducts having at least six faces;
the plurality of airducts arranged in transverse fashion in relation to one another;
the plurality of airducts having a plurality of openings in each of the at least six faces, wherein the plurality of openings are spaced along each of the plurality of airducts such that superficial segments without the plurality of openings are positioned between areas with the plurality of openings.

2. The geometric multiformat grain dryer of claim 1 further comprising the plurality of openings arranged in ventilation rings about the plurality of airducts, wherein plurality of openings in the ventilation rings are configured to permit communication of an airflow of drying air to an airflow of used air that exits.

3. The geometric multiformat grain dryer of claim 2 further comprising the ventilation rings are arranged in sequence, wherein the ventilation rings define a linear volume of airflow through the plurality of airducts.

4. The geometric multiformat grain dryer of claim 1 wherein the plurality of airducts having a first superior row of inlet airducts and a first inferior row of inlet airducts with a first row of outlet airducts positioned therebetween, and an airflow of drying air traversing through the first superior row of inlet airducts and the first inferior row of inlet airducts descends from the first superior row of inlet airducts and ascends from the first inferior row of inlet airducts, wherein the airflow of drying airflow becomes an airflow of used air upon entry into the first row of outlet airducts.

5. The geometric multiformat grain dryer of claim 4 wherein the first superior row of inlet airducts, the first inferior row of inlet airducts, and the first row of outlet airducts form a first module; and a second superior row of inlet airducts, a second inferior row of inlet airducts, and a second row of outlet airducts form a second module; and wherein the first module and the second module provide an orthogonal air.

6. The geometric multiformat grain dryer of claim 5 further comprising a grain flow received through a superior opening in the first grain drying tower, the second grain drying tower, and the third grain drying tower, wherein the grain flow undergoes a first 180° rotation during its descent through the first module and a second 180° rotation during its descent through the second module.

7. The geometric multiformat grain dryer of claim 1 further comprising a heater centrally located between the first grain drying tower, the second grain drying tower, and the third grain drying tower.

8. The geometric multiformat grain dryer of claim 1 further comprising the external face of the first grain drying tower, the second grain drying tower, and the third grain drying tower having the plurality of airducts closed off by a plurality of lids, such that an airflow passing through the first grain drying tower, the second grain drying tower, and the third grain drying tower only exits the external face of the geometric multiformat grain dryer by way of at least one fan positioned between the first grain drying tower and the second grain drying tower.

9. The geometric multiformat grain dryer of claim 1 wherein the first grain drying tower, the second grain drying tower, and the third grain drying tower are arranged in a triangle.

10. The geometric multiformat grain dryer of claim 1 wherein the first grain drying tower, the second grain drying tower, the third grain drying tower, and a fourth grain drying tower are arranged in a square.

11. The geometric multiformat grain dryer of claim 1 wherein the first grain drying tower, the second grain drying tower, the third grain drying tower, a fourth grain drying tower, and a fifth grain drying tower are arranged in a pentagon.

12. The geometric multiformat grain dryer of claim 1 further comprising an insulation formed by a first layer of air between a first internal wall and a second internal wall, and a second layer of air between the second internal wall and ends of the plurality of the airducts closest to the second layer of air.

13. A geometric multiformat grain dryer comprising:
a plurality of grain drying towers connected to one another by a plurality of exhaust housings having a suction diffuser on an exterior face;
the plurality of grain drying towers having a plurality of modules;
at least two of the plurality of modules each having a superior row of inlet airducts, an inferior row of inlet airducts, and a row of outlet airducts that is positioned between the superior row of inlet airducts and the inferior row of inlet airducts, wherein the superior row of inlet airducts and the inferior row of inlet airducts extend perpendicularly in relation to the row of outlet airducts;
the superior row of inlet airducts and the inferior row of inlet airducts each having:
at least one inlet airduct that extends from a first opened end to a second closed end;
a plurality of ventilation rings positioned between the first opened end and the second closed end;
and at least two superficial segments interspaced about the plurality of airducts;
the row of outlet airducts having at least one outlet airduct that extends from a first opened end to a second opened end;
a heater positioned centrally between the plurality of grain drying towers;
the first opened end of the at least one inlet airduct in communication with the dryers;
wherein the first opened end and the second opened end of the at least one outlet airduct is in communication with suction diffusers of the plurality of exhaust housings.
